(19) United States
(12) Patent Application Publication
(10) Pub. No.: US 2024/0319341 A1
(43) Pub. Date: Sep. 26, 2024

(54) DISTANCE MEASURING DEVICE AND DISTANCE MEASURING METHOD

(71) Applicant: SONY SEMICONDUCTOR SOLUTIONS CORPORATION, KANAGAWA (JP)

(72) Inventors: RYOHEI KAZAMA, KANAGAWA (JP); NOBUAKI KAJI, KANAGAWA (JP)

(21) Appl. No.: 18/574,763

(22) PCT Filed: Mar. 3, 2022
(86) PCT No.: PCT/JP2022/009112

§ 371 Date: Dec. 28, 2023

(30) Foreign Application Priority Data
Jul. 7, 2021 (JP) 2021-112820

(51) Int. Cl. G01S 7/484; G01S 17/58

(52) U.S. Cl. CPC G01S 7/484; G01S 17/58

(57) ABSTRACT

A distance measuring device (1, 1A, 1B) includes a plurality of light sources (10A to 10D), a light source controller (310, 310B), a light receiving section (20), a distance measurement processing section (320, 320B), a prediction section (350), and a determination section (360). The plurality of light sources (10A to 10D) each have mutually different irradiation regions, and apply light to a target object in the irradiation region. The light source controller (310, 310B) controls the plurality of light sources (10A to 10D). The light receiving section (20) has a light receiving region corresponding to the irradiation region, and receives the reflected light from the target object for each light receiving region. The distance measurement processing section (320, 320B) performs distance measurement processing for calculating a distance to the target object based on the reflected light. The prediction section (350) predicts a motion of the target object within a distance measurement target range. The determination section (360) determines a light source to be turned on to perform light emission among the plurality of light sources (10A to 10D) based on the predicted motion of the target object.

### FIELD

The present disclosure relates to a distance measuring device and a distance measuring method.

### BACKGROUND

In a distance measurement using a time of flight (ToF) method, irradiation light is emitted from a light emitting source such as an infrared laser diode to an object, and the irradiation light is reflected by a surface of the object as reflected light and then is detected by a distance measuring device. The distance to the object is calculated based on the time of flight, that is, a time from the emission of the irradiation light to the reception of the reflected light.

As the distance measuring device that calculates the distance to the object in this manner, there is known a distance measuring device that individually adjusts turning on or off of a plurality of light emitting sources, thereby suppressing ambient light due to multipath and preventing deterioration of measurement distance accuracy.

### CITATION LIST

### Patent Literature

Patent Literature 1: JP 2019-45334 A

### SUMMARY

### Technical Problem

The above distance measuring device does not pay a special attention to a case where an object to be a distance measurement target moves. For example, in a case where an object being a distance measurement target moves out of the irradiation region of the light emitting source that is turned on, the distance measuring device cannot calculate the distance to the object, leading to the possibility of deterioration of distance measurement accuracy.

In view of this, the present disclosure proposes a distance measuring device and a distance measuring method capable of further suppressing deterioration of distance measurement accuracy.

Note that the above problem or target is merely one of a plurality of problems or targets that can be solved or achieved by a plurality of embodiments disclosed in the present specification.

### Solution to Problem

According to the present disclosure, a distance measuring device is provided. The distance measuring device includes a plurality of light sources, a light source controller, a light receiving section, a distance measurement processing section, a prediction section, and a determination section. The plurality of light sources each have mutually different irradiation regions, and apply light to a target object in the irradiation region. The light source controller controls the plurality of light sources. The light receiving section has a light receiving region corresponding to the irradiation region, and receives the reflected light from the target object for each light receiving region. The distance measurement processing section performs distance measurement processing for calculating a distance to the target object based on the reflected light. The prediction section predicts a motion of the target object within a distance measurement target range. The determination section determines a light source to be turned on to perform light emission among the plurality of light sources based on the predicted motion of the target object.

### BRIEF DESCRIPTION OF DRAWINGS

FIG. 1 is a diagram illustrating an outline of a distance measuring device according to a first embodiment of the present disclosure.

FIG. 2 is a diagram illustrating a distance calculation method by using the distance measuring device according to the first embodiment of the present disclosure.

FIG. 3 is a diagram illustrating an outline of a distance measuring method using the distance measuring device according to the first embodiment of the present disclosure.

FIG. 4 is a diagram illustrating an outline of a distance measuring method using the distance measuring device according to the first embodiment of the present disclosure.

FIG. 5 is a diagram illustrating an outline of a distance measuring method using the distance measuring device according to the first embodiment of the present disclosure.

FIG. 6 is a block diagram illustrating a configuration example of a distance measuring device according to the first embodiment of the present disclosure.

FIG. 7 is a diagram illustrating a method of selecting a light source by a determination section according to the first embodiment of the present disclosure.

FIG. 8 is a diagram illustrating a method of selecting a light source by the determination section according to the first embodiment of the present disclosure.

FIG. 9 is a flowchart illustrating an example of a flow of distance measurement processing according to the first embodiment of the present disclosure.

FIG. 10 is a diagram illustrating an example of a method of selecting a light source by a determination section according to a first modification of the first embodiment of the present disclosure.

FIG. 11 is a flowchart illustrating an example of a flow of distance measurement processing according to the first modification of the first embodiment of the present disclosure.

FIG. 12 is a block diagram illustrating a configuration example of a distance measuring device according to a second modification of the first embodiment of the present disclosure.

FIG. 13 is a block diagram illustrating a configuration example of a distance measuring device according to a second embodiment of the present disclosure.

FIG. 14 is a diagram illustrating an example of a boundary light receiving element according to the second embodiment of the present disclosure.

FIG. 15 is a view illustrating an example of light reception in the boundary light receiving element according to the second embodiment of the present disclosure.

FIG. 16 is a diagram illustrating an example of a distance measuring device adjustment method according to the second embodiment of the present disclosure.

FIG. 17 is a diagram illustrating an example of a distance measuring device adjustment method according to the second embodiment of the present disclosure.

FIG. 18 is a diagram illustrating an example of a distance measuring device adjustment method according to the second embodiment of the present disclosure.

FIG. 19 is a flowchart illustrating a flow of adjustment processing according to the second embodiment of the present disclosure.

FIG. 20 is a block diagram illustrating a schematic configuration example of a vehicle control system, which is an example of a moving body control system to which the technology according to the present disclosure is applicable.

FIG. 21 is a diagram illustrating an example of an installation position of an imaging section.

### DESCRIPTION OF EMBODIMENTS

Hereinafter, embodiments of the present disclosure will be described in detail with reference to the accompanying drawings. Note that redundant descriptions will be omitted from the present specification and the drawings by assigning the same reference signs to components having substantially the same functional configuration.

Furthermore, in the present specification and the drawings, similar components in the embodiments may be distinguished by adding different alphabets after the same reference numerals. However, in a case where it is not necessary to particularly distinguish each of the similar components from each other, the same reference numerals are given with no alphabets.

One or more embodiments (examples and modifications) described below can each be implemented independently. On the other hand, at least some of the plurality of embodiments described below may be appropriately combined with at least some of other embodiments. The plurality of embodiments may include novel features different from each other. Accordingly, the plurality of embodiments can contribute to achieving or solving different objects or problems, and can exhibit different effects.

### 1. First Embodiment

### <1.1. Overview of Distance Measuring Device>

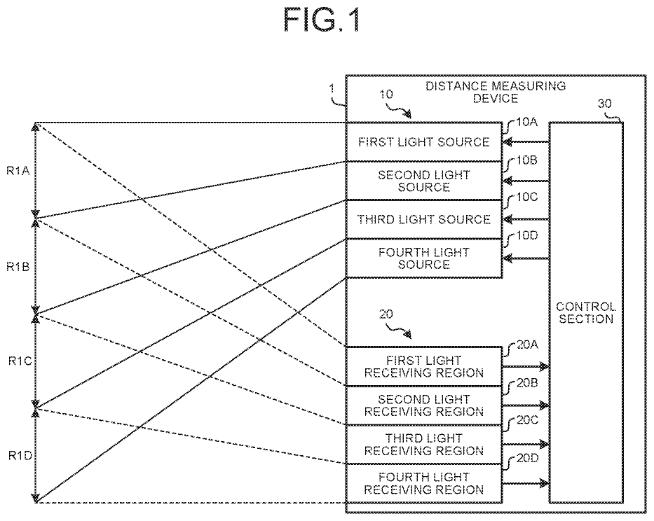

FIG. 1 is a diagram illustrating an outline of a distance measuring device 1 according to an embodiment of the present disclosure. As illustrated in FIG. 1, the distance measuring device 1 includes a light source section 10, a light receiving section 20, and a control section 30.

The distance measuring device 1 is a device that emits light from the light source section 10, receives reflected light being light reflected from a surface of an object by the light receiving section 20, and calculates the distance to the object.

### (Light Source Section 10)

The light source section 10 includes first to fourth light sources 10A to 10D having mutually different irradiation regions. The first to fourth light sources 10A to 10D emit light such as infrared light (IR).

In the example of FIG. 1, the first light source 10A applies light to a first irradiation region R1A. The second light source 10B applies light to a second irradiation region RIB adjacent to the first irradiation region R1A. The third light source 10C applies light to a third irradiation region R1C adjacent to the second irradiation region R1B. The fourth light source 10D applies light to a fourth irradiation region R1D adjacent to the third irradiation region R1C.

Based on an instruction from the control section 30, the light source section 10 performs radiation of light by turning on at least one of the first to fourth light sources 10A to 10D to perform light emission.

Note that the number of light sources included in the light source section 10 is not limited to four. The light sources included in the light source section 10 only need to be provided in plurality, and may be three or less or five or more. The first to fourth irradiation regions R1A to R1D of the first to fourth light sources 10A to 10D are not limited to the example of FIG. 1. The first to fourth irradiation regions R1A to R1D may have any shape. The first to fourth irradiation regions R1A to R1D may partially overlap each other.

(Light receiving section 20)

The light receiving section 20 is constituted with a complementary metal oxide semiconductor (CMOS) image sensor, for example. The light receiving section 20 receives, through a lens (not illustrated), reflected light, which is light emitted from the light source section 10 and reflected by a target object.

The light receiving section 20 includes first to fourth light receiving regions 20A to 20D each corresponding to the first to fourth irradiation regions R1A to R1D of the first to fourth light sources 10A to 10D, respectively.

For example, the first light receiving region 20A is a region of disposing a light receiving element (not illustrated) that receives the reflected light which has been reflected by the target object in the first irradiation region R1A. The second light receiving region 20B is a region of disposing the light receiving element that receives the reflected light which has been reflected by the target object in the second irradiation region R1B. The third light receiving region 20C is a region of disposing the light receiving element that receives the reflected light which has been reflected by the target object in the third irradiation region R1C. The fourth light receiving region 20D is a region of disposing the light receiving element that receives the reflected light which has been reflected by the target object in the fourth irradiation region R1D.

Based on an instruction from the control section 30, the light receiving section 20 receives light in a light receiving region corresponding to the light source that has emitted light among the first to fourth light sources 10A to 10D. The light receiving section 20 outputs a pixel signal (detection signal) corresponding to the amount of received light to the control section 30.

The control section 30 determines a light source and a light receiving region to be used for light emission according to the position of the target object of distance measurement, notifies the light source section 10 of information related to the determined light source and notifies the light receiving section 20 of information related to the light receiving region. The control section 30 calculates the distance to the target object based on the detection signal acquired from the light receiving section 20.

### <1.2. Outline of Distance Measuring Method>

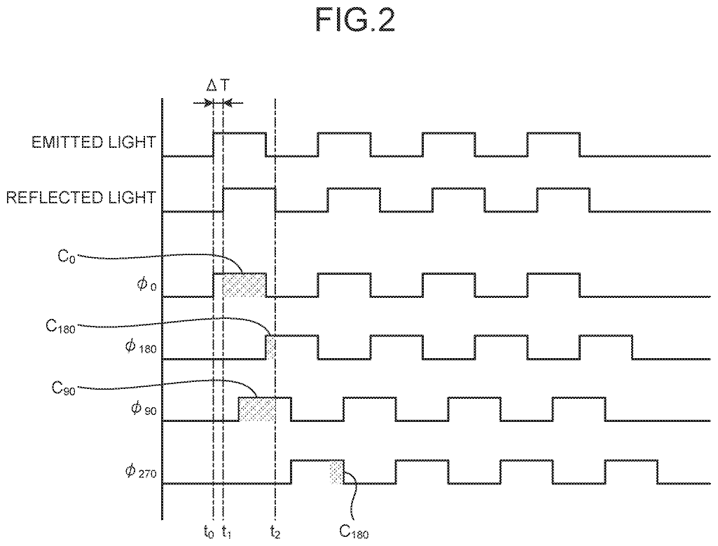

FIG. 2 is a diagram illustrating a distance calculation method by using the distance measuring device 1 according to the first embodiment of the present disclosure. An example of the distance measuring device 1 according to the first embodiment is an indirect time-of-flight (iToF) sensor that performs distance measurement by an iToF method and outputs distance information.

As illustrated in FIG. 2, when light is emitted from the light source section 10, the emitted light is reflected by a target object Ob and received by the light receiving section 20 as reflected light. This reflected light reaches the light receiving section 20 a predetermined time ΔT (t₀−t₁) delayed compared to the emitted light due to the time of flight of the light. This allows the light receiving section 20 to generate a charge corresponding to the reflected light for one pulse of the emitted light. Here, a light receiving pulse signal φ₀ synchronized with the emitted light (phase difference: 0°) is input to the light receiving section 20, and this leads to an output of a charge amount C₀ (as a distance measuring signal) corresponding to an overlapping period between the light receiving period (t₁−t₂) of the reflected light and the light receiving pulse signal φ₀, among the generated charges.

Similarly, the charge amount C₁₈₀ is output by a light receiving pulse signal φ180 with a phase difference of 180°, the charge amount Coo is output by a light reception pulse signal φ₉₀ with a phase difference of 90°, and a charge amount C₂₇₀ is output by a light receiving pulse signal φ270 with a phase difference of 270°.

The distance measuring device 1 calculates distance data from the charge amounts C₀, C₁₈₀, C₉₀, and C₂₇₀ according to the following Formula. From the charge amounts C₀, C₁₈₀, C₉₀, and C₂₇₀, a difference I and a difference Q in Formulas (1) and (2) are obtained.

$$I = {C}_{0} - {C}_{180} \qquad ( 1 )$$

$$Q = {C}_{90} - {C}_{270} \qquad ( 2 )$$

Furthermore, from these differences I and Q, a phase difference Phase (0≤Phase<2π) is calculated by Formula (3).

$$Phase = {tan}^{- 1} ( Q / I ) \qquad ( 3 )$$

From the above, distance data Distance is calculated by Formula (4).

$$Distance = c \times Phase / 4 π f \qquad ( 4 )$$

Here, c represents the speed of light, and f represents the frequency of the emitted light.

The distance measuring device 1 obtains the distance data Distance for each pixel and arranges the distance data Distance in an array corresponding to the pixel array, thereby generating a depth map indicating a relative distance to the target object Ob.

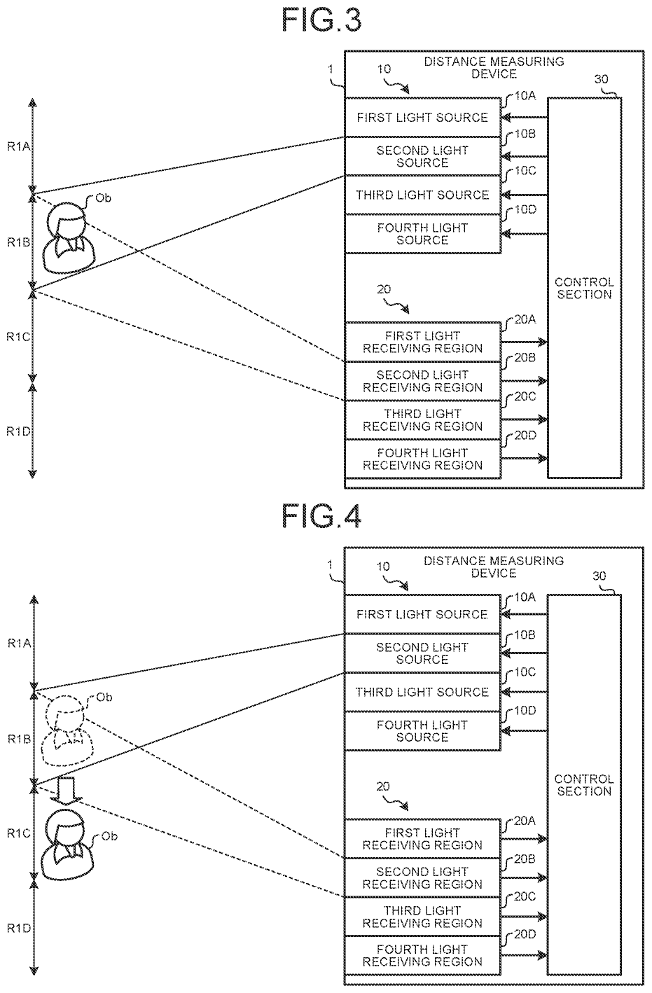

Next, FIGS. 3 to 5 are diagrams illustrating an outline of a distance measuring method using the distance measuring device 1 according to the first embodiment of the present disclosure.

As illustrated in FIG. 3, when the target object Ob (a person in FIG. 2) is located in the second irradiation region R1B of the second light source 10B, the control section 30 controls the light source section 10 to turn on the second light source 10B to perform light emission. Furthermore, the control section 30 controls the light receiving section 20 to receive the reflected light in the second light receiving region 20B corresponding to the second irradiation region R1B.

This makes it possible for the distance measuring device 1 to calculate the distance to the target object Ob. In addition, the distance measuring device 1 suppresses light emissions from the first, third, and fourth light sources 10A, 10C, and 10D, which are not used for distance measurement of the target object Ob. The distance measuring device 1 suppresses light reception in the first, third, and fourth light receiving regions 20A, 20C, and 20D. In this manner, the distance measuring device 1 suppresses driving of the light source and the light receiving region that are not used for distance measurement of the target object Ob, making it possible for the distance measuring device 1 to further reduce power consumption.

Here is an assumable case, as illustrated in FIG. 4, where the target object Ob moves out of the second irradiation region R1B. In FIG. 4, the target object Ob is outside the second irradiation region R1B by moving from the second irradiation region R1B to the third irradiation region R1C.

In this manner, when the target object Ob goes out of the second irradiation region R1B being a current irradiation region during distance measurement by the distance measuring device 1 with the light emitted by the second light source 10B, the distance measuring device 1 cannot calculate the distance to the target object Ob, leading to deterioration of distance measurement accuracy.

Therefore, the distance measuring device 1 according to the first embodiment of the present disclosure predicts the motion of the target object Ob in a light receiving range of the light receiving section 20. Here, the light receiving range of the light receiving section 20 is a range in which the reflected light can be received by the first to fourth light receiving regions 20A to 20D, and is a distance measuring range (hereinafter, also referred to as a field angle) in which the distance measuring device 1 can perform distance measurement.

Based on the predicted motion of the target object Ob, the distance measuring device 1 determines a light source to be turned on for light emission among the first to fourth light sources 10A to 10D. For example, as illustrated in FIG. 4, when it is predicted that the target object Ob is going out of the current second irradiation region R1B because of the movement of the target object Ob from the second irradiation region R1B to the third irradiation region R1C, the distance measuring device 1 determines to perform light emission of the third light source 10C corresponding to the third irradiation region R1C to which the target object Ob is going to move.

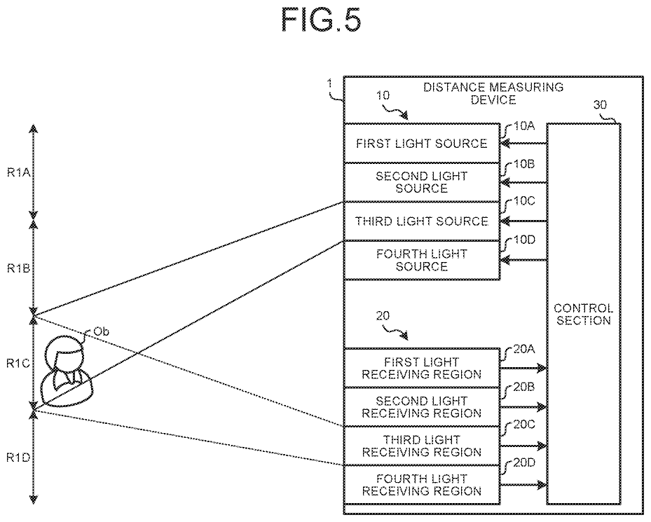

With this configuration, as illustrated in FIG. 5, even when the target object Ob moves from the second irradiation region R1B to the third irradiation region R1C, the distance measuring device 1 can use the third light receiving region 20C to receive the reflected light which is obtained by reflection of light from the third light source 10C by the target object Ob. This makes it possible for the distance measuring device 1 to calculate the distance to the target object Ob.

The distance measuring device 1 according to the first embodiment of the present disclosure includes the first to fourth light sources 10A to 10D that have the mutually different first to fourth irradiation regions R1A to R1D and that apply light to the target object Ob in the first to fourth irradiation regions R1A to R1D, respectively. The distance measuring device 1 includes the light receiving section 20 that has the first to fourth light receiving regions 20A to 20D corresponding to the first to fourth irradiation regions R1A to R1D and that receives reflected light from the target object Ob for each of the first to fourth light receiving regions 20A to 20D.

The distance measuring device 1 predicts the motion of the target object Ob within the light receiving range of the light receiving section 20, and determines the light source to be turned on for light emission among the first to fourth light sources 10A to 10D based on the predicted motion of the target object Ob.

With this configuration, even when the target object Ob moves, the distance measuring device 1 can further improve the distance measurement accuracy of the target object Ob with reduced power consumption.

### <1.3. Configuration Example of Distance Measuring Device>

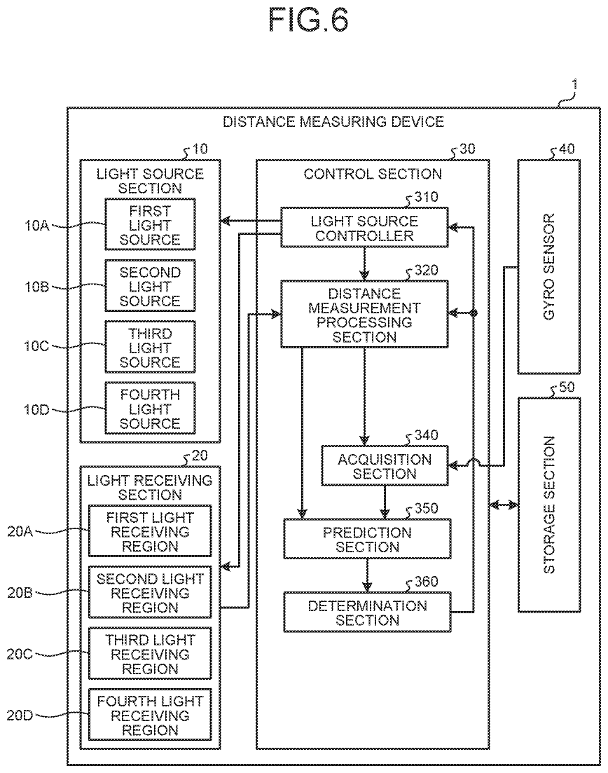

FIG. 6 is a block diagram illustrating a configuration example of the distance measuring device 1 according to the first embodiment of the present disclosure. The distance measuring device 1 illustrated in FIG. 6 includes a light source section 10, a light receiving section 20, a control section 30, a gyro sensor 40, and a storage section 50.

### [Light Source Section 10]

As described above, the light source section 10 includes the first to fourth light sources 10A to 10D. Each of the first to fourth light sources 10A to 10D includes one or more laser light sources such as a Vertical Cavity Surface Emitting Laser (VCSEL), for example. Under the control of the control section 30, the first to fourth light sources 10A to 10D emit irradiation light using predetermined light emission intensity, irradiation method, modulation frequency, and light emission period.

### [Light Receiving Section 20]

The light receiving section 20 includes a plurality of light receiving elements (referred to as pixels, not illustrated) two-dimensionally arranged in a matrix. The light receiving area of the light receiving section 20 is divided into first to fourth light receiving regions 20A to 20D respectively corresponding to the first to fourth irradiation regions R1A to R1D of the first to fourth light sources 10A to 10D. The plurality of light receiving elements are disposed in the first to fourth light receiving regions 20A to 20D.

The light receiving section 20 receives the reflected light, which is light emitted from the light source section 10 and reflected by the target object Ob, generates a charge corresponding to the amount of received light as a detection signal, and outputs the generated detection signal to the control section 30.

### [Gyro Sensor 40]

The gyro sensor 40 detects an angular velocity (inclination) of axial rotational motion of the distance measuring device 1 or a device installing the distance measuring device 1. The gyro sensor 40 outputs the detected angular velocity to the control section 30.

### [Storage Section 50]

The storage section 50 may include read only memory (ROM) that stores various types of programs executed by the control section 30 and random access memory (RAM) that stores various types of parameters, operation results, sensor values, or the like. In addition, the storage section 50 may be implemented by a magnetic storage device such as a hard disc drive (HDD) or the like, a semiconductor storage device, an optical storage device, a magneto-optical storage device, or the like.

### [Control Section 30]

The control section 30 is a controller that controls individual parts of the distance measuring device 1. The control section 30 can include, for example, an arithmetic device such as a central processing unit (CPU) or a microprocessor unit (MPU) mounted on the distance measuring device 1 or an application program operating on the arithmetic device. The control section 30 may include, for example, a programmable logic device (PLD) such as a field programmable gate array (FPGA) or other devices such as an application specific integrated circuit (ASIC). Furthermore, as described below, for example, the control section 30 can include a laser diode driver (LDD) for controlling the light source section 10.

In the present embodiment, the control section 30 includes a light source controller 310, a distance measurement processing section 320, an acquisition section 340, a prediction section 350, and a determination section 360, and executes a distance measuring method described below.

Individual blocks constituting the control section 30 are functional blocks individually indicating functions of the control section 30. These functional blocks may be software blocks or hardware blocks. For example, each of the functional blocks described above may be one software module actualized by software (including a microprogram) or one circuit block on a semiconductor chip (die). Needless to say, each of the functional blocks may be formed as one processor or one integrated circuit. The functional block may be configured by using any method. Note that the control section 30 may be configured in a functional unit different from the above-described functional block.

### (Light Source Controller 310)

The light source controller 310 controls the light source section 10. For example, the light source controller 310 selects a light source having a region determined by the determination section 360 described below as an irradiation region, and controls the light source. The light source controller 310 controls the light source section 10 to perform light emission satisfying light emission conditions such as light emission timing, light emission intensity, and an irradiation method. Furthermore, the light source controller 310 supplies drive information for driving the light receiving section 20 to the light receiving section 20 in accordance with the light emission condition.

Note that the light source controller 310 can be implemented by an LDD. Alternatively, the light source section 10 may include an LDD separately from the light source controller 310. In this case, the light source controller 310 selects a light source to be turned on for light emission and sets light emission conditions of the selected light source. When the light emission conditions set by the light source controller 310 are supplied to the LDD, the LDD turns on the light source to perform light emission based on the light emission condition.

### (Distance Measurement Processing Section 320)

The distance measurement processing section 320 calculates distance data Distance (depth value) of each pixel based on the detection signal of each light receiving element (pixel) supplied from the light receiving section 20. The distance measurement processing section 320 generates a depth frame storing distance data Distance as a pixel value of each pixel. The distance measurement processing section 320 outputs the generated depth frame to the prediction section 350.

### (Acquisition Section 340)

The acquisition section 340 acquires a detection result of the gyro sensor 40. For example, the acquisition section 340 calculates the rotation angle of the distance measuring device 1 based on the angular velocity acquired from the gyro sensor 40. The acquisition section 340 notifies the prediction section 350 and the determination section 360 of the rotation angle of the distance measuring device 1.

### (Prediction Section 350)

The prediction section 350 predicts the motion of the target object Ob of distance measurement. The prediction section 350 predicts the motion of the target object Ob using a known motion vector detection technique, for example. For example, the prediction section 350 detects, as a motion vector, a difference between the target object Ob in a target frame (an example of a first frame) and the target object Ob in a reference frame (an example of a second frame) coming before the target frame. Here, the motion vector includes at least one piece of information of the moving speed, the moving amount, and the moving direction of the target object Ob.

The prediction section 350 predicts the position of the target object Ob within the field angle in a prediction frame (an example of a third frame) coming subsequent to the target frame based on the detected motion vector, thereby predicting the motion of the target object Ob. The prediction section 350 predicts, in the prediction frame, where the target object Ob is located within the field angle.

In addition, in a case where the acquisition section 340 has acquired information regarding the rotation of the distance measuring device 1, that is, in a case where the movement of the distance measuring device 1 has been detected, the prediction section 350 predicts the motion of the target object Ob within the field angle in accordance with the movement of the distance measuring device 1.

Based on the rotation angle of the distance measuring device 1 acquired by the acquisition section 340 and the distance data Distance to the target object Ob calculated by the distance measurement processing section 320, the prediction section 350 calculates the relative moving direction and the moving distance of the target object Ob within the field angle. With this configuration, the prediction section 350 predicts the position of the target object Ob in the prediction frame.

The prediction section 350 notifies the determination section 360 of the predicted position (for example, the irradiation region).

### (Determination Section 360)

The determination section 360 determines a light source to be turned on for light emission in accordance with the motion of the target object Ob predicted by the prediction section 350 and the motion of the distance measuring device 1 acquired by the acquisition section 340.

Based on the position (hereinafter, also referred to as a predicted position) of the target object Ob within the field angle predicted by the prediction section 350, the determination section 360 determines a light source to be turned on for light emission. The determination section 360 determines a light source having an irradiation region including the predicted position as a light source to be turned on to perform light emission.

In addition, the determination section 360 turns on all the light sources to perform light emission at a predetermined cycle. With this configuration, even in a case where a target object enters a region other than the region in which distance measurement is being performed, that is, a region other than the irradiation region of the light source that emits light, the distance measuring device 1 can measure the distance without missing the target object.

At this time, in accordance with the motion of the distance measuring device 1, the determination section 360 changes the cycle of entire light emission, which is a mode of performing light emissions by all the light sources. For example, the determination section 360 shortens the cycle of entire light emission in a case where the distance measuring device 1 moves by a predetermined amount (predetermined rotation angle) or more. In contrast, in a case where the distance measuring device 1 has substantially no motion and the moving amount (rotation angle) is less than the predetermined amount, the determination section 360 elongates the cycle of entire light emission. Note that the cycle of the entire light emission may have an upper limit and a lower limit.

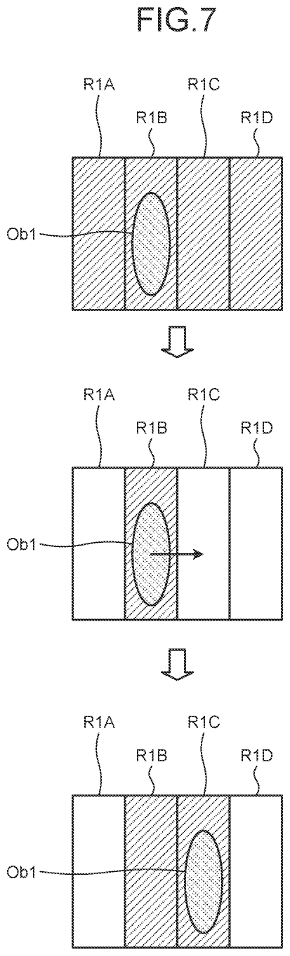

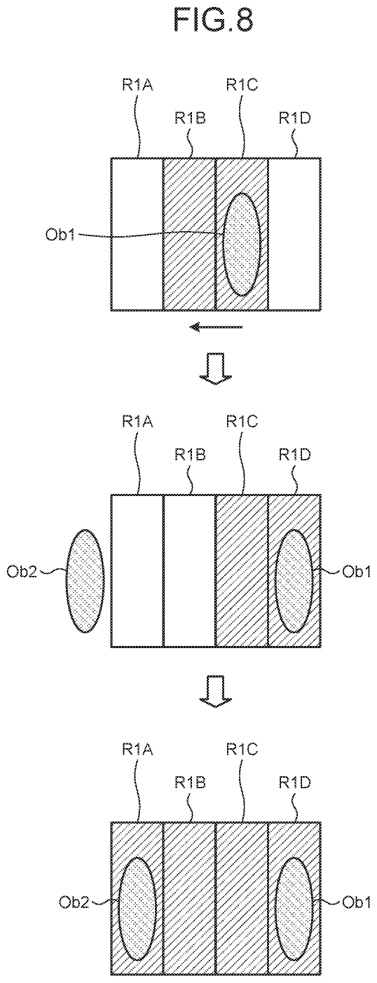

Here, an example of a method of selecting a light source by the determination section 360 will be described with reference to FIGS. 7 and 8. FIGS. 7 and 8 are diagrams illustrating a method of selecting a light source by the determination section 360 according to the first embodiment of the present disclosure.

The determination section 360 selects all light sources as light sources to be emitted at the start of distance measurement or at a predetermined cycle. With this configuration, as illustrated in the upper diagram of FIG. 7, light is applied to all the first to fourth irradiation regions R1A to R1D. The distance measurement processing section 320 calculates distance data Distance of a target object Ob1 located in the second irradiation region R1B.

Next, the determination section 360 determines the second light source 10B that applies light to the second irradiation region R1B where the target object Ob1 is located, as a light source that emits light. With this configuration, as illustrated in the middle diagram of FIG. 7, light is applied to the second irradiation region R1B while light is not applied to the other regions, namely, first, third, and fourth irradiation regions R1A, R1C, and R1D. In this manner, even when light is applied to a part of the irradiation region, the distance measurement processing section 320 can calculate the distance data Distance of the target object Ob1.

Here, it is assumed that the prediction section 350 has detected an arrow illustrated in the middle diagram of FIG. 7 as the motion vector of the target object Ob1. In this case, the determination section 360 predicts that the target object Ob1 is going to move to the third irradiation region R1C in the next frame, and determines the second light source 10B and the third light source 10C that will apply light to the second irradiation region R1B and the third irradiation region R1C respectively, as light sources to be turned on for light emission. With this configuration, as illustrated in the lower diagram of FIG. 7, light is applied to the second and third irradiation regions R1B and R1C, making it possible for the distance measurement processing section 320 to calculate the distance to the target object Ob1 even when the target object Ob1 has moved to the third irradiation region R1C.

In this manner, in addition to the third light source 10C that applies light to the third irradiation region R1C predicted to move, the determination section 360 determines the second light source 10B that has previously performed light emission, as the light source to be turned on for current light emission. This makes it possible for the distance measuring device 1 to measure the distance to the target object Ob1 more reliably.

Next, here is an assumable state where the second light source 10B and the third light source 10C are emitting light and the distance measuring device 1 is measuring the distance to the target object Ob1 in the third irradiation region R1C (refer to the lower diagram of FIG. 7), and the distance measuring device 1 moves as indicated by the arrow in the upper diagram of FIG. 8. In this case, the acquisition section 340 detects the rotation in the left direction in the drawing.

Based on the detection result of the acquisition section 340, the prediction section 350 predicts the motion of the target object Ob1 within the field angle. For example, the prediction section 350 predicts that the target object Ob1 will move from the third irradiation region R1C to the fourth irradiation region R1D. The determination section 360 determines the third light source 10C that applies light to the third irradiation region R1C where the target object Ob1 is located in the current frame and the fourth light source 10D that applies light to the fourth irradiation region R1D to which the target object Ob1 is predicted to move, as light sources to be used for light emission. With this configuration, as illustrated in the middle diagram of FIG. 8, even when the position of the target object Ob1 in the field angle is moved with the movement of the distance measuring device 1, the distance measuring device 1 can measure the distance to the target object Ob1.

In addition, the determination section 360 shortens the cycle of entire light emission in accordance with the movement of the distance measuring device 1. With this configuration, for example, as illustrated in the lower diagram of FIG. 8, the distance measuring device 1 turns on all the light sources (the first to fourth light sources 10A to 10D) to perform light emission in a short cycle in distance measurement. This makes it possible for the distance measuring device 1 to measure, for example, the distance to a target object Ob2 that has entered the field angle due to the movement of the distance measuring device 1, without missing the target object Ob2.

### <1.4. Distance Measurement Processing>

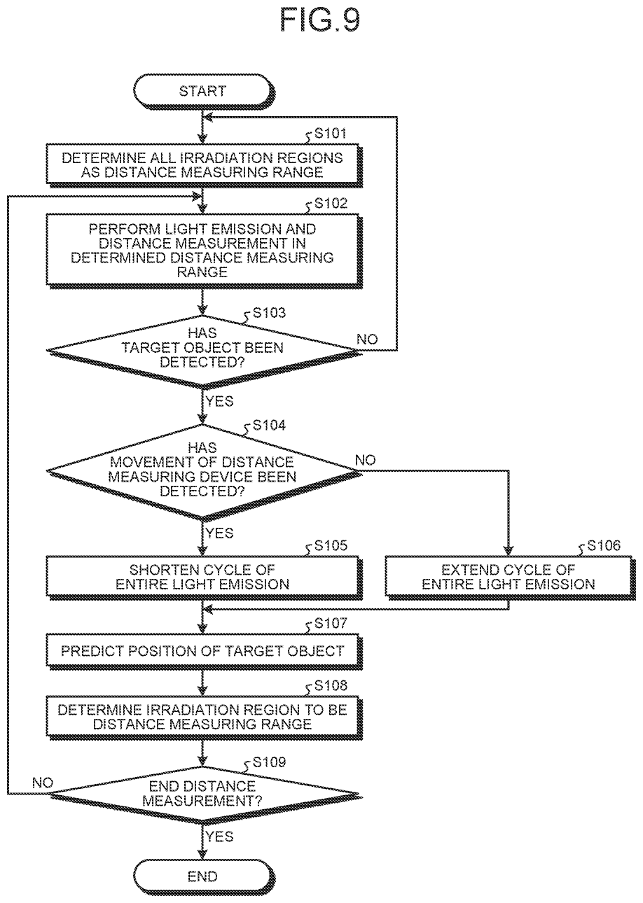

FIG. 9 is a flowchart illustrating an example of a flow of distance measurement processing according to the first embodiment of the present disclosure. The distance measurement processing illustrated in FIG. 9 is executed by the distance measuring device 1. The distance measuring device 1 executes the distance measurement processing illustrated in FIG. 9 when distance measurement is started, for example.

As illustrated in FIG. 9, first, the distance measuring device 1 determines all the irradiation regions (first to fourth irradiation regions R1A to R1D) as a distance measuring range (step S101).

Next, the distance measuring device 1 performs light emission and distance measurement in the distance measuring range determined in step S101 (step S102). For example, the distance measuring device 1 turns on all the light sources (the first to fourth light sources 10A to 10D) to perform light emission in the distance measurement.

The distance measuring device 1 determines whether the target object Ob has been detected by the distance measurement in step S102 (step S103). When the target object Ob has not been detected (step S103; No), the processing return to step S101.

In contrast, when the target object Ob has been detected (step S103; Yes), the distance measuring device 1 determines whether the movement of the distance measuring device 1 has been detected (step S104). For example, the distance measuring device 1 detects the movement of the distance measuring device 1 in a case where the rotation amount (rotation angle) of the distance measuring device 1 is a predetermined threshold or more based on the detection result of the gyro sensor 40.

When the movement of the distance measuring device 1 is detected (step S104; Yes), the distance measuring device 1 shortens the cycle of entire light emission (step S105). In contrast, in a case where the movement of the distance measuring device 1 has not been detected (step S104; No), the distance measuring device 1 extends the cycle of entire light emission (step S106).

Next, the distance measuring device 1 predicts the position of the target object Ob in the next frame, for example (step S107). The distance measuring device 1 determines an irradiation region to be a distance measuring range in accordance with the prediction result (step S108). For example, the distance measuring device 1 determines, as the distance measuring range, an irradiation region corresponding to the position of the target object Ob in the current frame and an irradiation region corresponding to the position of the target object Ob predicted in the next frame. In addition, the distance measuring device 1 determines all the irradiation regions as the distance measuring range in the next frame in accordance with the cycle of entire light emission.

That is, in a case where the next frame is the timing of entire light emission, the distance measuring device 1 determines all the irradiation regions as the distance measuring range. Otherwise, the distance measuring device 1 determines the distance measuring range according to the predicted position of the target object Ob.

Next, the distance measuring device 1 determines whether to end the distance measurement (step S109). In the case of not ending the distance measurement (step S109; No), the distance measuring device 1 returns to step S102, and measures the distance to the target object Ob by emitting light in the distance measuring range. In contrast, in the case of ending the distance measurement (step S109; Yes), the distance measuring device 1 ends the distance measurement processing.

As described above, the distance measuring device 1 according to the first embodiment of the present disclosure includes the first to fourth light sources 10A to 10D (plurality of light sources) that have the mutually different first to fourth irradiation regions R1A to R1D, and that apply light to the target object Ob in the first to fourth irradiation regions R1A to R1D. In addition, the distance measuring device 1 includes the light source controller 310 that controls the first to fourth light sources 10A to 10D. The distance measuring device 1 includes the light receiving section 20 that has the first to fourth light receiving regions 20A to 20D corresponding to the first to fourth irradiation regions R1A to R1D and that receives reflected light from the target object Ob for each of the first to fourth light receiving regions 20A to 20D.

The distance measuring device 1 includes the distance measurement processing section 320 that performs distance measurement processing for calculating the distance to the target object Ob based on the reflected light. The distance measuring device 1 includes the prediction section 350 that predicts the motion of the target object Ob within the light receiving range (field angle) of the light receiving section 20. The distance measuring device 1 includes the determination section 360 that determines a light source to be turned on for light emission among the first to fourth light sources 10A to 10D based on the predicted motion of the target object Ob.

With this configuration, the distance measuring device 1 can perform distance measurement by using an appropriate light source for light emission even when the target object Ob moves, and can further improve the distance measurement accuracy of the target object Ob while suppressing an increase in power consumption.

### 2. First Modification

In the first embodiment described above, the determination section 360 shortens the entire light emission cycle in a case where the distance measuring device 1 moves. However, the present invention is not limited thereto. The determination section 360 may select a light source to be used for light emission in accordance with the movement of the distance measuring device 1.

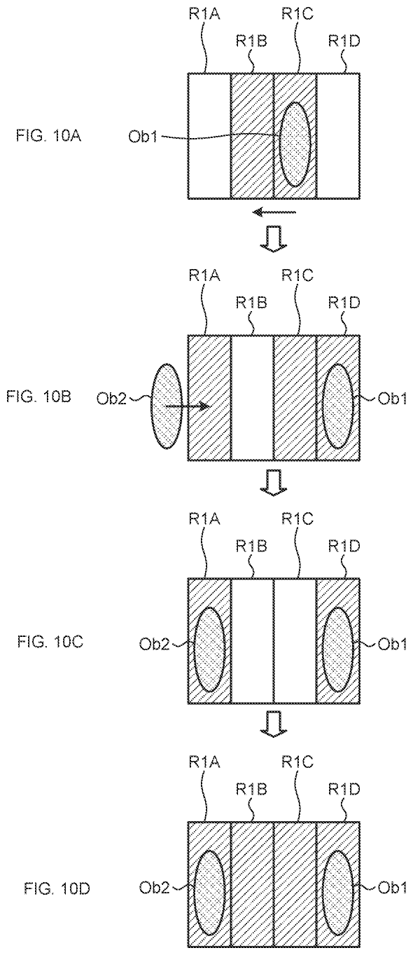

FIG. 10 is a diagram illustrating an example of a method of selecting a light source by the determination section 360 according to a first modification of the first embodiment of the present disclosure.

As illustrated in FIG. 10 (a), here is an assumable case where the distance measuring device 1 has moved to the left side of the drawing. In this case, it is considered that the user has moved the distance measuring device 1 to perform distance measurement of the target object Ob2 located on the left side of the distance measuring device 1. Therefore, as illustrated in FIG. 10 (b), it is highly probable that the target object Ob2 will enter from the left side of the field angle.

Therefore, in accordance with the movement and moving direction of the distance measuring device 1, in addition to the third and fourth light sources 10C and 10D that respectively apply light to the third and fourth irradiation regions R1C and R1D, the determination section 360 determines the first light source 10A that applies light to the first irradiation region R1A located on the left side of the field angle as a light source to be used for light emission. This makes it possible for the distance measuring device 1 to more reliably measure the distance to the target object Ob2 entering from the outside of the field angle.

Next, as illustrated in FIG. 10 (c), based on the positions of the detected target objects Ob1 and Ob2, the determination section 360 determines the first and fourth light sources 10A and 10D that respectively apply light to the first and fourth irradiation regions R1A and R1D as light sources to be used for performing next light emission.

In addition, as illustrated in FIG. 10 (d), in accordance with the entire light emission cycle, the determination section 360 determines the first to fourth light sources 10A to 10D as light sources to be used for light emission so as to apply light to all the irradiation regions. This makes it possible for the distance measuring device 1 to measure the distance more reliably without missing any target object Ob.

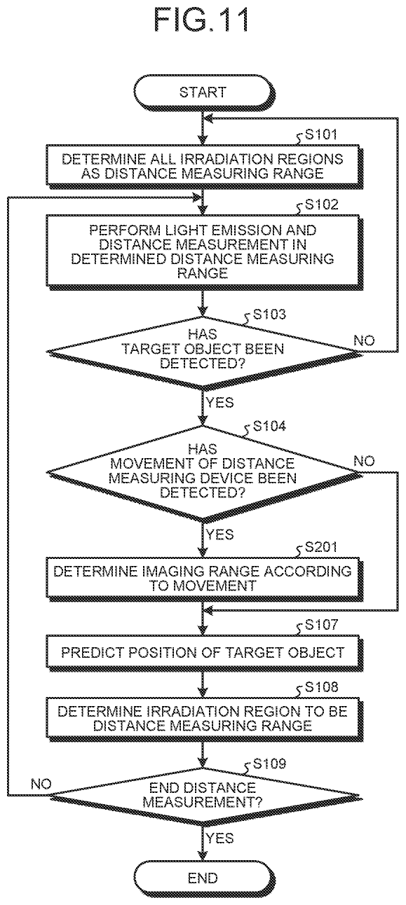

FIG. 11 is a flowchart illustrating an example of a flow of distance measurement processing according to the first modification of the first embodiment of the present disclosure. Note that the same processing as the distance measurement processing illustrated in FIG. 9 are denoted by the same reference numerals, and description thereof is omitted.

As illustrated in FIG. 11, when having detected the movement of the distance measuring device 1 in step S104, the distance measuring device 1 determines a distance measuring range according to the movement (step S201). For example, the distance measuring device 1 determines the irradiation region corresponding to the moving direction of the distance measuring device 1 as the distance measuring range. In addition, the distance measuring device 1 can determine the number of irradiation regions corresponding to the moving amount (or the moving speed) as the distance measuring range.

In this manner, the distance measuring device 1 determines the distance measuring range, in other words, the light source to be turned on for light emission in accordance with the moving direction of the distance measuring device 1, making it possible to further improve distance measurement accuracy while further suppressing the power consumption of the distance measuring device 1.

### 3. Second Modification

In the first embodiment and the first modification described above, the distance measuring device 1 detects the movement of the distance measuring device 1 based on the gyro sensor 40. However, the measurement is not limited thereto. The distance measuring device 1 may detect the movement of the distance measuring device 1 based on another sensor.

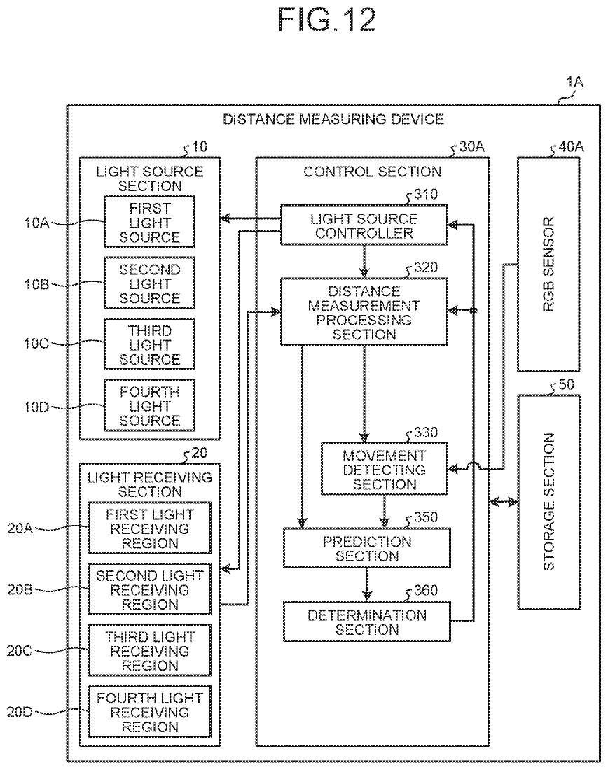

FIG. 12 is a block diagram illustrating a configuration example of a distance measuring device 1A according to a second modification of the first embodiment of the present disclosure. The distance measuring device 1A illustrated in FIG. 12 is different from the distance measuring device 1 illustrated in FIG. 6 in that an RGB sensor 40A is provided instead of the gyro sensor 40 and a movement detecting section 330 is provided instead of the acquisition section 340.

An RGB sensor 40A illustrated in FIG. 12 is, for example, an imaging sensor that captures an RGB color image. The RGB sensor 40A captures a color image at a predetermined frame rate and outputs the color image to a control section 30A. Note that the cycle (frame rate) at which the RGB sensor 40A captures a color image may be the same as or different from the cycle (frame rate) at which the distance measuring device 1A measures the distance of the target object Ob.

The movement detecting section 330 detects motions from the color image. When the distance measuring device 1A moves, the entire color image moves uniformly. Accordingly, in a case where the entire color image uniformly moves, the movement detecting section 330 detects the movement of the distance measuring device 1A. When having detected the movement of the distance measuring device 1A, the movement detecting section 330 detects the moving direction and the moving amount (or the moving speed) as a motion vector of the distance measuring device 1A, for example.

Alternatively, the movement detecting section 330 can detect the movement of the distance measuring device 1A based on a depth frame acquired from the distance measurement processing section 320. For example, the movement detecting section 330 determines that a pixel in which no distance has been calculated by the distance measurement processing section 320 is a pixel that has not detected the target object Ob, that is, the pixel is a pixel that has imaged the background, and then, calculates the motion vector based on the pixel.

The movement detecting section 330 calculates a motion vector based on pixels other than the pixels in which the distance measurement processing section 320 has calculated the distance, and sets a vector in a direction opposite to the calculated motion vector as a motion vector of the distance measuring device 1A. The movement detecting section 330 outputs the motion vector of the distance measuring device 1A to the prediction section 350 and the determination section 360.

The prediction section 350 and the determination section 360 predict the motion of the target object Ob and determine the light source to be turned on for light emission based on the motion vector of the distance measuring device 1A instead of the rotation amount of the distance measuring device 1.

In this manner, the distance measuring device 1A can detect the motion of the distance measuring device 1A using a sensor (for example, the RGB sensor 40A) other than the gyro sensor 40.

### 4. Second Embodiment

In the first embodiment and the individual modifications described above, the distance measuring device 1 performs simultaneous light emission in a plurality of light sources, for example, the third and fourth light sources 10C and 10D (refer to FIG. 7) in some cases. In such a case, the way of arrangement of wiring lines such as light sources and control lines might cause unmatched light emission timings of the plurality of light sources. Unmatched light emission timings of the plurality of light sources can lead to deterioration in distance measurement accuracy. In view of this, in a second embodiment of the present disclosure, a distance measuring device 1B adjusts light emission timings of the light sources to achieve matching in the light emission timings of the plurality of light sources, thereby suppressing deterioration in distance measurement accuracy.

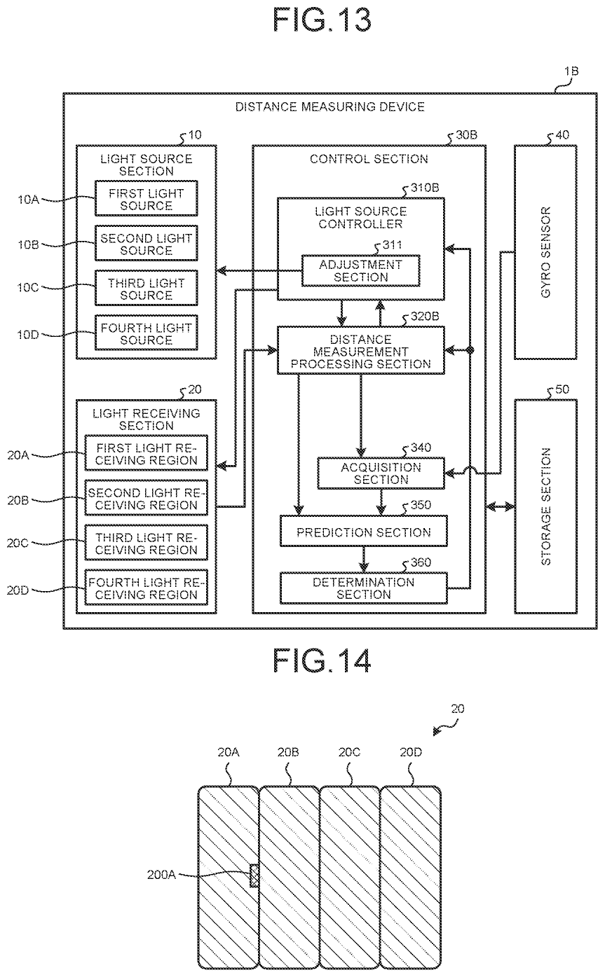

FIG. 13 is a block diagram illustrating a configuration example of the distance measuring device 1B according to the second embodiment of the present disclosure. Among the components of the distance measuring device 1B illustrated in FIG. 13, the same components as those of the distance measuring device 1 in FIG. 6 are denoted by the same reference numerals, and description thereof is omitted.

A light source controller 310B of a control section 30B includes an adjustment section 311. The adjustment section 311 adjusts the light emission timings of the plurality of light sources so that the plurality of light sources simultaneously emit light. The adjustment section 311 adjusts the light emission timings based on the distance calculated by a distance measurement processing section 320B. Details of the adjustment performed by the adjustment section 311 will be described below.

The distance measurement processing section 320B calculates the distance to the target object Ob. In the second embodiment, the distance measurement processing section 320B calculates the distance to the target object Ob based on the reflected light received by a boundary light receiving element 200 of the light receiving section 20. The distance measurement processing section 320B notifies the adjustment section 311 of the light source controller 310B of information related to the distance calculated based on the amount of light received by the boundary light receiving element 200.

Here, the boundary light receiving element 200 will be described with reference to FIG. 14. FIG. 14 is a diagram illustrating an example of the boundary light receiving element 200 according to the second embodiment of the present disclosure.

As illustrated in FIG. 14, the light receiving section 20 is divided into four light receiving regions (first to fourth light receiving regions 20A to 20D) corresponding to the first to fourth irradiation regions R1A to R1D of the first to fourth light sources 10A to 10D, respectively. In FIG. 14, each light receiving region has a rectangular shape, and is disposed such that the first and second light receiving regions 20A and 20B are adjacent to each other, the second and third light receiving regions 20B and 20C are adjacent to each other, and the third and fourth light receiving regions 20C and 20D are adjacent to each other.

Here, the boundary light receiving element 200 is a light receiving element disposed in a region adjacent to another light receiving region in each light receiving region. FIG. 14 illustrates an example of a boundary light receiving element 200A adjacent to the second light receiving region 20B in the first light receiving region 20A.

In this manner, the boundary light receiving element 200A disposed in the region adjacent to another light receiving region has a possibility of receiving the reflected light from the second irradiation region R1B adjacent to the first irradiation region R1A in addition to the reflected light from the corresponding first irradiation region R1A.

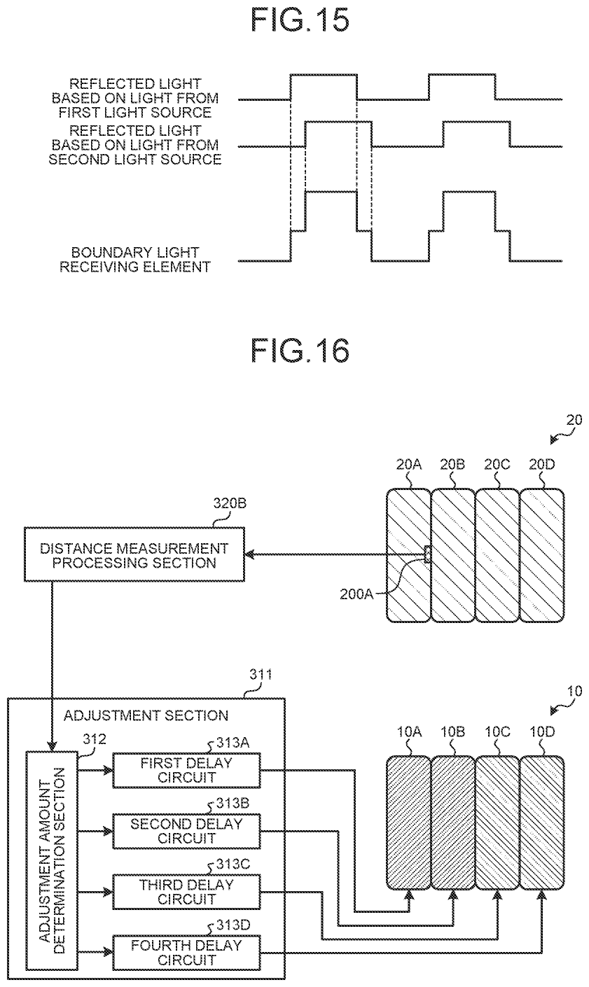

FIG. 15 is a view illustrating an example of light reception in the boundary light receiving element 200A according to the second embodiment of the present disclosure.

As described above, the boundary light receiving element 200A receives both the reflected light of the light applied to the first irradiation region R1A by the first light source 10A and the reflected light of the light applied to the second irradiation region R1B by the second light source 10B.

Here is an assumable case of unmatched timings of irradiations of the irradiation light from the first light source 10A and the irradiation light from the second light source 10B. As illustrated in FIG. 15, this leads to unmatched timings, that is, occurrence of a difference in the timing at which the reflected light from the first light source 10A reaches the boundary light receiving element 200A and the timing at which the reflected light from the second light source 10B reaches the boundary light receiving element 200A. The boundary light receiving element 200A receives combined light of the reflected light beams of the first and second light sources 10A and 10B. The pulse width and the waveform of the combined light do not match the pulse width and the waveform of the irradiation light of the first light source 10A and the second light source 10B, leading to a possibility that the distance measurement processing section 320B fails to correctly calculate the distance to the target object Ob.

Therefore, in a case where one light source among the plurality of adjacent light sources is used to emit light, the distance measuring device 1B according to the second embodiment of the present disclosure measures the distance from the reflected light received in a light receiving region corresponding to the irradiation region of the one light source to the target object Ob. In a case where the other light source is used to emit light, the distance measuring device 1B measures the distance to the target object Ob from the reflected light received in the light receiving region corresponding to the irradiation region of the one light source. The distance measuring device 1B adjusts the light emission timings of the plurality of adjacent light sources in accordance with the measurement results of the distance to the target object Ob.

FIGS. 16 to 18 are diagrams illustrating an example of an adjustment method of the distance measuring device 1B according to the second embodiment of the present disclosure. As illustrated in FIG. 16, the adjustment section 311 includes an adjustment amount determination section 312 and first to fourth delay circuits 313A to 313D.

The first to fourth delay circuits 313A to 313D are provided so as to correspond to the first to fourth light sources 10A to 10D, respectively, and adjust light emission timings of the first to fourth light sources 10A to 10D. The first to fourth delay circuits 313A to 313D are disposed in signal lines of timing signals controlling light emission of the first to fourth light sources 10A to 10D, and adjust light emission timings by delaying the timing signals. The first to fourth delay circuits 313A to 313D may be provided in power supply lines of the first to fourth light sources 10A to 10D.

The adjustment amount determination section 312 determines delay amounts (adjustment amounts) of the first to fourth delay circuits 313A to 313D based on the distance information calculated by the distance measurement processing section 320B.

For example, the adjustment amount determination section 312 groups two adjacent light sources as one set, and determines the delay amount for each set. The adjustment amount determination section 312 determines the delay amount for all the sets to adjust the light emission timings for all the light sources.

In FIG. 16, the adjustment amount determination section 312 determines the delay amounts of the first and second delay circuits 313A and 313B by using the first and second light sources 10A and 10B as one set.

For example, the adjustment section 311 first turns on the first light source 10A to perform light emission. The distance measurement processing section 320B calculates a distance (hereinafter, also referred to as a first distance) to the target object Ob using the light reception signal in the boundary light receiving element 200A. Next, the adjustment section 311 turns on the second light source 10B to perform light emission. The distance measurement processing section 320B calculates a distance (hereinafter, also referred to as a second distance) to the target object Ob using the light reception signal in the boundary light receiving element 200A.

Here, with unmatched light emission timings of the first light source 10A and the light emission of the second light source 10B, a difference occurs between the first distance and the second distance calculated by the distance measurement processing section 320B. Therefore, the adjustment amount determination section 312 determines an adjustment amount (delay amounts of first and second delay circuits 313A and 313B) to be used in adjusting the light emission timings of the first and second light sources 10A and 10B in accordance with the first distance and the second distance.

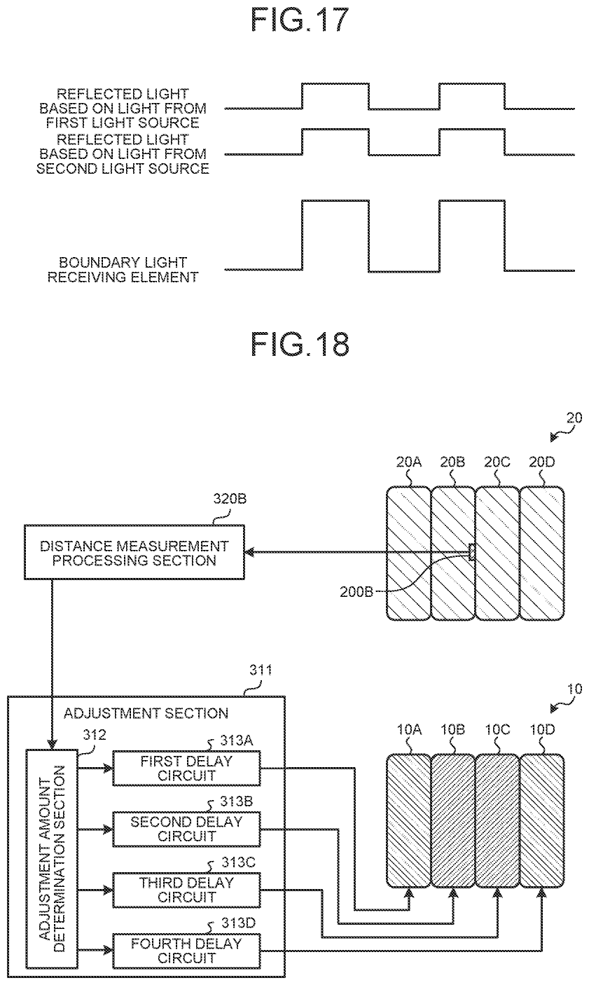

For example, when the light emission timing of the second light source 10B is late (refer to FIG. 15), the adjustment amount determination section 312 delays the light emission timing of the first light source 10A. This makes it possible to achieve matching in the light emission timings of the first and second light sources 10A and 10B as illustrated in FIG. 17. With this configuration, the distance measuring device 1B can adjust the pulse width and the waveform of the reflected light (combined light) received by the boundary light receiving element 200A to the pulse width and the waveform of the irradiation light of the first and second light sources 10A and 10B, making it possible to suppress deterioration in distance measurement accuracy.

Next, as illustrated in FIG. 18, the adjustment section 311 adjusts the light emission timing of the set of the second and third light sources 10B and 10C. First, the distance measurement processing section 320B calculates a distance (hereinafter, also referred to as a third distance) to the target object Ob based on the reflected light received by a boundary light receiving element 200B of the second light receiving region 20B when the second light source 10B is used for light emission.

Next, the distance measurement processing section 320B calculates a distance (hereinafter, also referred to as a fourth distance) to the target object Ob based on the reflected light received by the boundary light receiving element 200B of the second light receiving region 20B when the third light source 10C is used for light emission. The adjustment amount determination section 312 determines an adjustment amount (delay amounts of second and third delay circuits 313B and 313C) to be used in adjusting the light emission timings of the second and third light sources 10B and 10C in accordance with the third distance and the fourth distance.

In a case where unmatched light emission timings of the first light source 10A and the second light source 10B occur due to this adjustment, the adjustment amount determination section 312 may adjust the light emission timing of the first light source 10A. This makes it possible for the adjustment section 311 to achieve matching in the light emission timings of the first to third light sources 10A to 10C.

The adjustment section 311 similarly adjusts the light emission timings of the third and fourth light sources 10C and 10D. With this configuration, the adjustment section 311 can achieve matching in the light emission timings of the first to fourth light sources 10A to 10D, making it possible to suppress deterioration of the distance measurement accuracy due to unmatched light emission timings.

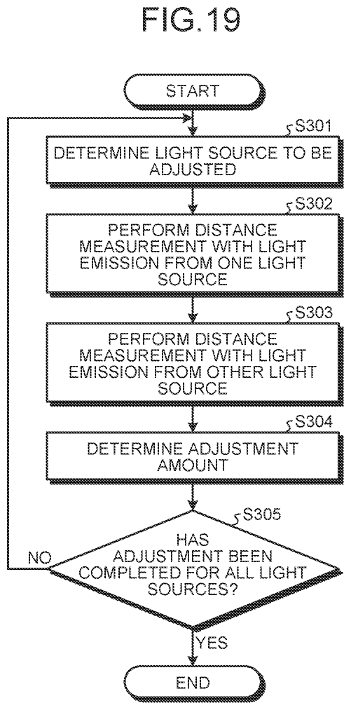

FIG. 19 is a flowchart illustrating a flow of adjustment processing according to the second embodiment of the present disclosure. The adjustment processing illustrated in FIG. 19 is executed by the distance measuring device 1B at a timing such as shipment or manufacturing.

The distance measuring device 1B determines a light source to be adjusted from among a plurality of light sources (step S301). From among the plurality of light sources, the distance measuring device 1B selects a set including two adjacent light sources, which is also a set including a light source that is not yet adjusted.

The distance measuring device 1B performs distance measurement by emitting light from one light source of the selected set of light sources (step S302). For example, the distance measuring device 1B emits light from one light source, and performs distance measurement using reflected light received by the boundary light receiving element 200 of the light receiving region corresponding to the irradiation region of the light source.

The distance measuring device 1B performs distance measurement by emitting light from the other light source among the selected set of light sources (step S303). For example, the distance measuring device 1B emits light from the other light source, and performs distance measurement using reflected light received by the boundary light receiving element 200 of the light receiving region corresponding to the irradiation region of the one light source described above.

Based on the distances measured in steps S302 and S303, the distance measuring device 1B determines the adjustment amount of the light emission timing of the selected set of light sources (step S304).

The distance measuring device 1B determines whether the adjustment of the light emission timing has been completed for all the light sources (step S305). In a case where there is a light source for which adjustment has not been completed (step S305; No), the distance measuring device 1B returns to step S301, and adjusts the light source for which adjustment has not been completed. In contrast, in a case where the adjustment has been completed for all the light sources (step S305; Yes), the distance measuring device 1B ends the processing.

As described above, the distance measuring device 1B according to the second embodiment of the present disclosure includes the distance measurement processing section 320B, which calculates the first distance from the reflected light received in the light receiving region corresponding to one light source among the plurality of light sources when the one light source is used for light emission. In a case where the other light source among the plurality of light sources is used for light emission, the distance measurement processing section 320B calculates the second distance from the reflected light received in the light receiving region corresponding to the one light source described above. Furthermore, the distance measuring device 1B includes the light source controller 310B, which adjusts light emission timings of the plurality of light sources based on the first distance and the second distance.

With this configuration, the distance measuring device 1B can achieve light emissions of the plurality of light sources at the same timing, making it possible to further suppress deterioration of distance measurement accuracy in a case of using the plurality of light sources to perform simultaneous light emission.

Note that, here, the light source controller 310 (for example, LDD) of the distance measuring device 1B is equipped with the adjustment section 311 including the first to fourth delay circuits 313A to 313D, but the configuration is not limited thereto. For example, the distance measuring device 1B may be equipped with a delay section including the first to fourth delay circuits 313A to 313D separately from the light source controller 310. For example, the delay section may be disposed in the light receiving section 20 or may be disposed between the light receiving section 20 and the light source controller 310B.

Here, the distance measuring device 1B performs distance measurement by emitting light from one light source of the plurality of light sources and then emitting light from the other light source, but is not limited thereto. It is sufficient that the light sources that emit light are different from each other. For example, the distance measuring device 1B may perform distance measurement by emitting light from one of the plurality of light sources, and then perform distance measurement by emitting light from both of the plurality of light sources. Even in this case, the distance measuring device 1B adjusts the light emission timings of the plurality of light sources so as to reduce the difference between the two distance measurement results.

### 5. Third Modification

In the second embodiment described above, the distance measuring device 1B adjusts the light emission timing by delaying the timing signal indicating the light emission timing using the first to fourth delay circuits 313A to 313D. However, the method of adjusting the light emission timing is not limited thereto. For example, the distance measuring device 1B may generate a timing signal in which the light emission timing is already adjusted.

In this case, the adjustment section 311 determines the adjustment amount (for example, the delay time) of the light emission timing based on the distance (for example, the first distance and the second distance) calculated by the distance measurement processing section 320B. The adjustment section 311 stores the determined adjustment amount in the storage section 50, for example.

The light source controller 310B generates a timing signal at the light emission timing based on the adjustment amount determined by the adjustment section 311, and then outputs the generated timing signal to the light receiving section 20. That is, in the second embodiment, the first to fourth delay circuits 313A to 313D delay the timing signal generated by the light source controller 310B, making it possible for the distance measuring device 1B to achieve matching in the light emission timings of the first to fourth light sources 10A to 10D.

On the other hand, in the third modification, the light source controller 310B in the distance measuring device 1B generates a timing signal in consideration of the delay amount for each of the first to fourth light sources 10A to 10D, thereby achieving matching of the light emission timings of the first to fourth light sources 10A to 10D. For example, the distance measuring device 1B adjusts the output timing of the signal controlling the light emission according to the delay amount, thereby achieving matching of the light emission timings of the first to fourth light sources 10A to 10D.

In this manner, also in a case where the light source controller 310B generates the timing signal in consideration of the delay amount, similarly to the second embodiment, the distance measuring device 1B can achieve matching of the light emission timings of the individual light sources, making it possible to suppress deterioration of distance measurement accuracy.

### 6. Application Example

The technology according to the present disclosure (the present technology) is applicable to various products. For example, the technology according to the present disclosure may be applied to devices mounted on any of mobile body such as automobiles, electric vehicles, hybrid electric vehicles, motorcycles, bicycles, personal mobility, airplanes, drones, ships, and robots.

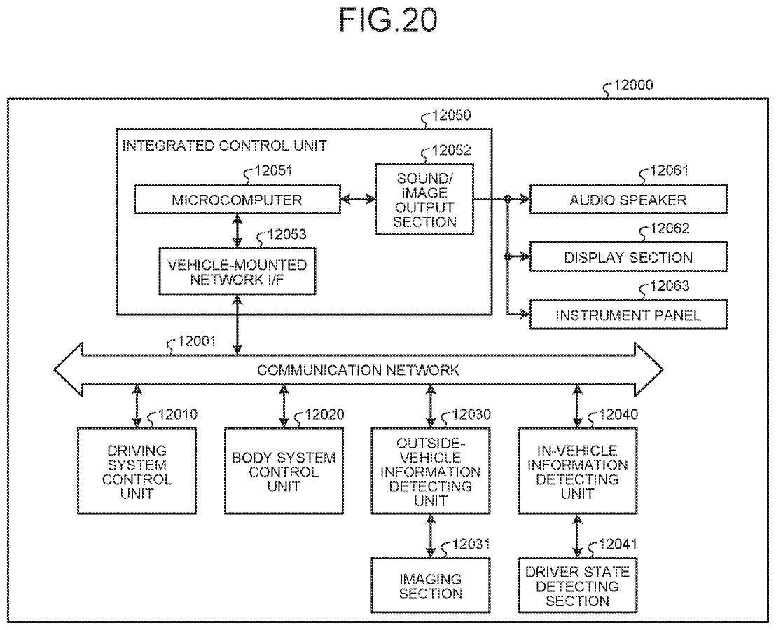

FIG. 20 is a block diagram illustrating an example of schematic configuration of a vehicle control system as an example of a mobile body control system to which the technology according to an embodiment of the present disclosure can be applied.

A vehicle control system 12000 includes a plurality of electronic control units connected to each other via a communication network 12001. In the example illustrated in FIG. 20, the vehicle control system 12000 includes a driving system control unit 12010, a body system control unit 12020, an outside-vehicle information detecting unit 12030, an in-vehicle information detecting unit 12040, and an integrated control unit 12050. In addition, a microcomputer 12051, a sound/image output section 12052, and a vehicle-mounted network interface (I/F) 12053 are illustrated as a functional configuration of the integrated control unit 12050.

The driving system control unit 12010 controls the operation of devices related to the driving system of the vehicle in accordance with various types of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various types of devices provided to a vehicle body in accordance with various types of programs. For example, the body system control unit 12020 functions as a control device for a keyless entry system, a smart key system, a power window device, or various types of lamps such as a headlamp, a backup lamp, a brake lamp, a turn signal, a fog lamp, or the like. In this case, radio waves transmitted from a mobile device as an alternative to a key or signals of various types of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 image an image of the outside of the vehicle, and receives the imaged image. Based on the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 is an optical sensor that receives light, and which outputs an electric signal corresponding to a received light amount of the light. The imaging section 12031 can output the electric signal as an image, or can output the electric signal as information about a measured distance. In addition, the light received by the imaging section 12031 may be visible light, or may be invisible light such as infrared rays or the like.

The in-vehicle information detecting unit 12040 detects information about the inside of the vehicle. The in-vehicle information detecting unit 12040 is, for example, connected with a driver state detecting section 12041 that detects the state of a driver. The driver state detecting section 12041, for example, includes a camera that images the driver. Based on detection information input from the driver state detecting section 12041, the in-vehicle information detecting unit 12040 may calculate a degree of fatigue of the driver or a degree of concentration of the driver, or may determine whether the driver is dozing.

The microcomputer 12051 can computes a control target value for the driving force generating device, the steering mechanism, or the braking device based on the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automated driving, which allows the vehicle to travel autonomously without depending on the operation of the driver, or the like, by controlling the driving force generating device, the steering mechanism, the braking device, or the like based on the information about the outside or inside of the vehicle which information is obtained by the outside-vehicle information detecting unit 12030 or the in-vehicle information detecting unit 12040.

In addition, the microcomputer 12051 can output a control command to the body system control unit 12020 based on the information about the outside of the vehicle which information is obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound and an image to an output device capable of visually or auditorily notifying information to an occupant of the vehicle or the outside of the vehicle. In the example of FIG. 20, an audio speaker 12061, a display section 12062, and an instrument panel 12063 are illustrated as the output device. The display section 12062 may, for example, include at least one of an on-board display and a head-up display.

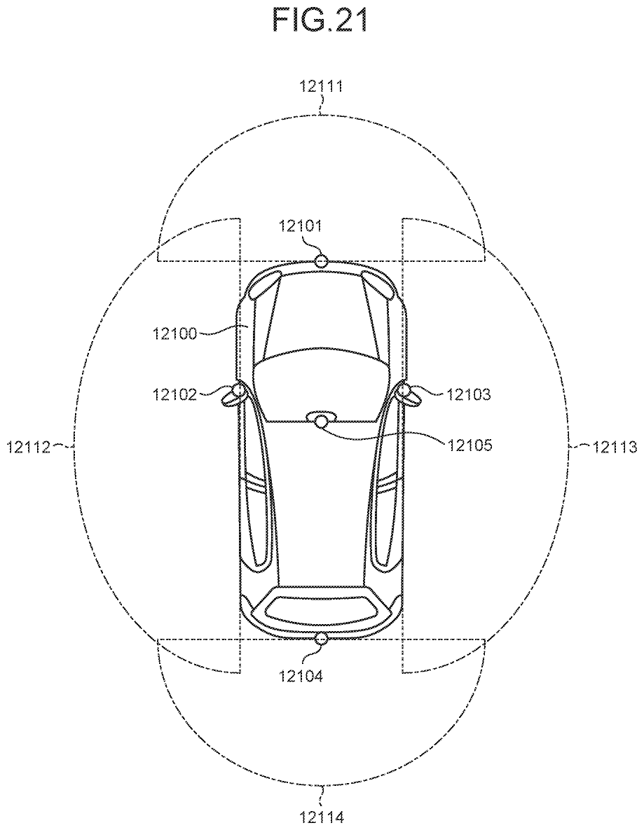

FIG. 21 is a diagram illustrating an example of the installation position of the imaging section 12031.

In FIG. 21, the imaging section 12031 includes imaging sections 12101, 12102, 12103, 12104, and 12105.

The imaging sections 12101, 12102, 12103, 12104, and 12105 are, for example, disposed at positions on a front nose, sideview mirrors, a rear bumper, and a back door of the vehicle 12100 as well as a position on an upper portion of a windshield within the interior of the vehicle. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the sideview mirrors obtain mainly an image of the sides of the vehicle 12100. The imaging section 12104 provided to the rear bumper or the back door obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like.

Incidentally, FIG. 21 illustrates an example of photographing ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the sideview mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) based on the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automated driving that allows the vehicle to travel autonomously without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects based on the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

### 7. Other Embodiments

Each of the above-described embodiments and the modifications is an example, and various modifications and applications are possible.

For example, in each of the above-described embodiments and modifications, the distance measuring devices 1, 1A, 1B turn on all of the first to fourth light sources 10A to 10D to perform light emission at a predetermined cycle in the distance measurement. However, the measurement is not limited thereto. In addition to or instead of the predetermined cycle, a cumulative value of the moving amount (rotation amount) of the distance measuring devices 1, 1A, 1B can be used, that is, the distance measuring devices 1, 1A, 1B may perform distance measurement by using entire light emission when the cumulative value reaches a predetermined value or more. With this configuration, even in a case where the moving speed (moving amount per single movement) of the distance measuring devices 1, 1A, 1B is a certain value or less, and the distance measuring devices 1, 1A, 1B are moving in a low speed, it is possible to further reduce the possibility of missing of the target object Ob due to the movement, making it possible to suppress deterioration of distance measurement accuracy.

Alternatively, it is possible to use a configuration in which the distance measuring devices 1, 1A, 1B may perform distance measurement by using entire light emission in a case where the distance measuring devices 1, 1A, 1B move at a predetermined speed (angular velocity) or more.

In addition, even in a case where the moving amount (rotation amount) of the distance measuring devices 1, 1A, 1B is smaller than a predetermined value, the distance measuring devices 1, 1A, 1B may shorten the cycle of entire light emission. In this case, the period to be shortened may be set shorter as compared with the case where the distance measuring devices 1, 1A, 1B have moved by a predetermined value or more. With this configuration, even when the distance measuring devices 1, 1A, 1B have moved, it is possible to further reduce the possibility of missing of the target object Ob due to the movement, achieving suppression of deterioration of distance measurement accuracy.

For example, in each of the above-described embodiments and modifications, the shapes of the first to fourth light sources 10A to 10D are rectangular, and the first to fourth light sources 10A to 10D are arranged in a line. However, the configuration not limited thereto. For example, the first to fourth light sources 10A to 10D may have a square shape, and the first to fourth light sources 10A to 10D may be arranged in a matrix. The first to fourth light sources 10A to 10D may have mutually different sizes.

Similarly, in each of the above-described embodiments and modifications, the shapes of the first to fourth light receiving regions 20A to 20D are rectangular, and the first to fourth light receiving regions 20A to 20D are arranged in a line. However, the configuration is not limited thereto. For example, the first to fourth light receiving regions 20A to 20D only need to correspond to the first to fourth irradiation regions R1A to R1D of the first to fourth light sources 10A to 10D, respectively, and may have square shapes, for example. In addition, the first to fourth light receiving regions 20A to 20D may be arranged in a matrix. In addition, the first to fourth light receiving regions 20A to 20D may have mutually different sizes.

In each embodiment and each modification, the distance measuring devices 1, 1A, 1B are configured to include the light source section 10, for example. However, the configuration is not limited thereto. For example, the light source section 10 and the light source controllers 310 and 310B may be configured as devices (for example, light source devices) different from the distance measuring devices 1, 1A, 1B. In this case, the functions of the light source controllers 310 and 310B may be implemented by being divided into a light source device and the distance measuring devices 1, 1A, 1B.

In addition, for example, the control device that controls the distance measuring devices 1, 1A, 1B of the embodiments and the modifications may be implemented by a dedicated computer system or a general-purpose computer system.

For example, a communication program for executing the above-described operations is stored in a computer-readable recording medium such as an optical disk, semiconductor memory, a magnetic tape, or a flexible disk and distributed. For example, the program is installed on a computer and the above processing is executed to achieve the configuration of the control device. At this time, the control device may be a device (for example, a personal computer) outside the distance measuring devices 1, 1A, 1B. Furthermore, the control device may be a device (for example, the control section 30, 30A, 30B) inside the distance measuring device 1, 1A, 1B.

Furthermore, the communication program may be stored in a disk device included in a server device on a network such as the Internet so as to be able to be downloaded to a computer, for example. Furthermore, the functions described above may be implemented by using operating system (OS) and application software in cooperation. In this case, the portions other than the OS may be stored in a medium for distribution, or the portions other than the OS may be stored in a server device so as to be downloaded to a computer, for example.

Furthermore, among individual processing described in each of the embodiments and modifications, all or a part of the processing described as being performed automatically may be manually performed, or the processing described as being performed manually can be performed automatically by known methods. In addition, the processing procedures, specific names, and information including various data and parameters illustrated in the above specifications or drawings can be changed in any manner unless otherwise specified. For example, a variety of information illustrated in each of the drawings are not limited to the information illustrated.

In addition, each of components of each device is provided as a functional and conceptional illustration and thus does not necessarily need to be physically configured as illustrated. That is, the specific form of distribution/integration of each of the devices is not limited to those illustrated in the drawings, and all or a part thereof may be functionally or physically distributed or integrated into arbitrary units according to various loads and use situations. This configuration by distribution and integration may be performed dynamically.

Furthermore, the above-described individual embodiments and modifications can be appropriately combined within a range implementable without contradiction of processes. Furthermore, the order of individual steps illustrated in the flowcharts of the above-described individual embodiments and modifications can be changed as appropriate.

Furthermore, for example, each of the above embodiments and modifications can be implemented as any configuration constituting a device or a system, for example, a processor as a large scale integration (LSI) or the like, a module using a plurality of processors or the like, a unit using a plurality of modules or the like, or a set obtained by further adding other functions to the unit (that is, a configuration of a part of the device).

In each of the above embodiments and modifications, a system represents a set of a plurality of components (devices, modules (components), or the like), and whether all the components are in the same housing would not be a big issue. Therefore, a plurality of devices housed in separate housings and connected via a network, and one device in which a plurality of modules are housed in one housing, are both systems.

### 8. Conclusion

The embodiments of the present disclosure have been described above. However, the technical scope of the present disclosure is not limited to the above-described embodiments, and various modifications can be made without departing from the scope of the present disclosure. Moreover, it is allowable to combine the components across different embodiments and modifications as appropriate.

The effects described in individual embodiments of the present specification are merely examples, and thus, there may be other effects, not limited to the exemplified effects.

Note that the present technique can also have the following configurations.

(1)

A distance measuring device comprising:
a plurality of light sources each having mutually different irradiation regions and configured to apply light to a target object in the irradiation region;
a light source controller that controls the plurality of light sources;
a light receiving section having a light receiving region corresponding to the irradiation region and configured to receive reflected light from the target object for each of the light receiving regions;
a distance measurement processing section that performs distance measurement processing for calculating a distance to the target object based on the reflected light;
a prediction section that predicts a motion of the target object within a distance measurement target range; and
a determination section that determines the light source to be turned on for light emission among the plurality of light sources based on the predicted motion of the target object.
   (2)

The distance measuring device according to (1), wherein the prediction section predicts a position of the target object in a third frame, which comes after a second frame, the prediction performed by using at least one of a moving speed, a moving amount, and a moving direction of the target object, based on the target object detected in the first frame and the target object detected in the second frame, the second frame coming before the first frame.

(3)

The distance measuring device according to (1) or (2), wherein the prediction section predicts the motion of the target object based on a motion of the distance measuring device detected by a sensor.

(4)

The distance measuring device according to anyone of (1) to (3), wherein, when the target object is predicted to move out of the irradiation region being a current region, the determination section determines to perform light emission by using the light source corresponding to the irradiation region to which the target object is going to move.

(5)

The distance measuring device according to anyone of (1) to (4), wherein the determination section determines the light source to be turned on for light emission based on a motion of the distance measuring device detected by a sensor.

(6)

The distance measuring device according to (5), wherein, when the distance measuring device is detected to have moved, the determination section determines the light source to be turned on for light emission in accordance with a moving direction of the distance measuring device.

(7)

The distance measuring device according to anyone of (1) to (6), wherein the determination section selects, at a predetermined cycle, all light sources as light sources to be turned on for light emission.

(8)

The distance measuring device according to (7), wherein the determination section changes the predetermined cycle in accordance with a motion of the distance measuring device.

(9)

The distance measuring device according to (8), wherein the determination section shortens the predetermined cycle when the distance measuring device has moved.

(10)

The distance measuring device according to anyone of (1) to (9),
wherein the distance measurement processing section
turns on a first light source among the plurality of light sources to perform light emission to calculate a first distance from the reflected light received in a first light receiving region corresponding to the first light source, and turns on a second light source adjacent to the first light source to perform light emission to calculate a second distance from the reflected light received in the first light receiving region, and
the light source controller
adjusts light emission timings of the first light source and the second light source based on the first distance and the second distance.
   (11)

A distance measuring device comprising:
a plurality of light sources each having mutually different irradiation regions and configured to apply light to a target object in the irradiation region;
a light source controller that controls the plurality of light sources;
a light receiving section having a light receiving region corresponding to the irradiation region and configured to receive reflected light from the target object for each of the light receiving regions; and
a distance measurement processing section that performs distance measurement processing for calculating a distance to the target object based on the reflected light,
wherein, in a case where a first light source among the plurality of light sources is turned on to perform light emission, the distance measurement processing section calculates a first distance from the reflected light received in a first light receiving region corresponding to the first light source, and in a case where a second light source adjacent to the first light source is turned on to perform light emission, the distance measurement processing section calculates a second distance from the reflected light received in the first light receiving region, and
the light source controller adjusts light emission timings of the first light source and the second light source based on the first distance and the second distance.
   (12)

The distance measuring device according to (11), wherein the light source controller further includes a delay circuit that adjusts the light emission timing.

(13)

The distance measuring device according to (11) or (12), wherein the distance measurement processing section calculates the first distance and the second distance from the reflected light received by a light receiving element in the first light receiving region, the light receiving element being adjacent to a second light receiving region corresponding to the second light source.

(14)

A distance measuring method comprising:
controlling a plurality of light sources each having mutually different irradiation regions and configured to apply light to a target object in the irradiation region;
performing distance measurement processing for calculating a distance to the target object based on reflected light from the target object received by a light receiving section, the light receiving section having a light receiving region corresponding to the irradiation region and configured to receive the reflected light for each of the light receiving regions;
predicting a motion of the target object within a distance measurement target range; and
determining the light source to be turned on to perform light emission among the plurality of light sources based on the predicted motion of the target object.
   (15)

A distance measuring method comprising:
controlling a plurality of light sources each having mutually different irradiation regions and configured to apply light to a target object in the irradiation region;
performing distance measurement processing for calculating a distance to the target object based on reflected light from the target object received by a light receiving section, the light receiving section having a light receiving region corresponding to the irradiation region and configured to receive the reflected light for each of the light receiving regions;
calculating a first distance from the reflected light received in a first light receiving region corresponding to a first light source among the plurality of light sources when the first light source is turned on to perform light emission;
calculating a second distance from the reflected light received in the first light receiving region when a second light source adjacent to the first light source is turned on to perform light emission; and
adjusting light emission timings of the first light source and the second light source based on the first distance and the second distance.

### REFERENCE SIGNS LIST

1 DISTANCE MEASURING DEVICE
10 LIGHT SOURCE SECTION
20 LIGHT RECEIVING SECTION
30 CONTROL SECTION
40 GYRO SENSOR
40A RGB SENSOR
50 STORAGE SECTION
310 LIGHT SOURCE CONTROLLER
320 DISTANCE MEASUREMENT PROCESSING SECTION
330 MOVEMENT DETECTING SECTION
340 ACQUISITION SECTION
350 PREDICTION SECTION
360 DETERMINATION SECTION

1. A distance measuring device comprising:
a plurality of light sources each having mutually different irradiation regions and configured to apply light to a target object in the irradiation region;
a light source controller that controls the plurality of light sources;
a light receiving section having a light receiving region corresponding to the irradiation region and configured to receive reflected light from the target object for each of the light receiving regions;
a distance measurement processing section that performs distance measurement processing for calculating a distance to the target object based on the reflected light;
a prediction section that predicts a motion of the target object within a distance measurement target range; and
a determination section that determines the light source to be turned on for light emission among the plurality of light sources based on the predicted motion of the target object.

2. The distance measuring device according to claim 1, wherein the prediction section predicts a position of the target object in a third frame, which comes after a second frame, the prediction performed by using at least one of a moving speed, a moving amount, and a moving direction of the target object, based on the target object detected in the first frame and the target object detected in the second frame, the second frame coming before the first frame.

3. The distance measuring device according to claim 1, wherein the prediction section predicts the motion of the target object based on a motion of the distance measuring device detected by a sensor.

4. The distance measuring device according to claim 1, wherein, when the target object is predicted to move out of the irradiation region being a current region, the determination section determines to perform light emission by using the light source corresponding to the irradiation region to which the target object is going to move.

5. The distance measuring device according to claim 1, wherein the determination section determines the light source to be turned on for light emission based on a motion of the distance measuring device detected by a sensor.

6. The distance measuring device according to claim 5, wherein, when the distance measuring device is detected to have moved, the determination section determines the light source to be turned on for light emission in accordance with a moving direction of the distance measuring device.

7. The distance measuring device according to claim 1, wherein the determination section selects, at a predetermined cycle, all light sources as light sources to be turned on for light emission.

8. The distance measuring device according to claim 7, wherein the determination section changes the predetermined cycle in accordance with a motion of the distance measuring device.

9. The distance measuring device according to claim 8, wherein the determination section shortens the predetermined cycle when the distance measuring device has moved.

10. The distance measuring device according to claim 1,
wherein the distance measurement processing section
turns on a first light source among the plurality of light sources to perform light emission to calculate a first distance from the reflected light received in a first light receiving region corresponding to the first light source, and turns on a second light source adjacent to the first light source to perform light emission to calculate a second distance from the reflected light received in the first light receiving region, and
the light source controller
adjusts light emission timings of the first light source and the second light source based on the first distance and the second distance.

11. A distance measuring device comprising:
a plurality of light sources each having mutually different irradiation regions and configured to apply light to a target object in the irradiation region;
a light source controller that controls the plurality of light sources;
a light receiving section having a light receiving region corresponding to the irradiation region and configured to receive reflected light from the target object for each of the light receiving regions; and
a distance measurement processing section that performs distance measurement processing for calculating a distance to the target object based on the reflected light,
wherein, in a case where a first light source among the plurality of light sources is turned on to perform light emission, the distance measurement processing section calculates a first distance from the reflected light received in a first light receiving region corresponding to the first light source, and in a case where a second light source adjacent to the first light source is turned on to perform light emission, the distance measurement processing section calculates a second distance from the reflected light received in the first light receiving region, and
the light source controller adjusts light emission timings of the first light source and the second light source based on the first distance and the second distance.

12. The distance measuring device according to claim 11, wherein the light source controller further includes a delay circuit that adjusts the light emission timing.

13. The distance measuring device according to claim 11, wherein the distance measurement processing section calculates the first distance and the second distance from the reflected light received by a light receiving element in the first light receiving region, the light receiving element being adjacent to a second light receiving region corresponding to the second light source.

14. A distance measuring method comprising:
controlling a plurality of light sources each having mutually different irradiation regions and configured to apply light to a target object in the irradiation region;
performing distance measurement processing for calculating a distance to the target object based on reflected light from the target object received by a light receiving section, the light receiving section having a light receiving region corresponding to the irradiation region and configured to receive the reflected light for each of the light receiving regions;
predicting a motion of the target object within a distance measurement target range; and
determining the light source to be turned on to perform light emission among the plurality of light sources based on the predicted motion of the target object.

15. A distance measuring method comprising:
controlling a plurality of light sources each having mutually different irradiation regions and configured to apply light to a target object in the irradiation region;
performing distance measurement processing for calculating a distance to the target object based on reflected light from the target object received by a light receiving section, the light receiving section having a light receiving region corresponding to the irradiation region and configured to receive the reflected light for each of the light receiving regions;
calculating a first distance from the reflected light received in a first light receiving region corresponding to a first light source among the plurality of light sources when the first light source is turned on to perform light emission;
calculating a second distance from the reflected light received in the first light receiving region when a second light source adjacent to the first light source is turned on to perform light emission; and
adjusting light emission timings of the first light source and the second light source based on the first distance and the second distance.
